(19) United States
(12) Patent Application Publication
(10) Pub. No.: US 2006/0033430 A1
(43) Pub. Date: Feb. 16, 2006

(54) Organic light emitting device and display apparatus provided with the organic light emitting device

(75) Inventor: Chao-Chi Peng, Tainan Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Lightronik Technology Inc.

(21) Appl. No.: 10/915,814

(22) Filed: Aug. 11, 2004

(51) Int. Cl. H05B 33/04

(52) U.S. Cl. 313/512; 313/495

(57) ABSTRACT

An organic light emitting device includes a substrate, an organic light emitting diode mounted on the substrate, a cover covering the organic light emitting diode, a sealing band disposed between and connected sealingly to the cover and the substrate so as to cooperate with the substrate and the cover to define a closed space thereamong and so as to seal the organic light emitting diode in the closed space, and a coupling mechanism having an isolating member that is disposed in the closed space and that is connected sealingly to the cover and the substrate, and a through-hole that extends through the cover, the isolating member, and the substrate for extension of a connecting member of a display apparatus therethrough.

### BACKGROUND OF THE INVENTION

1. Field of the Invention

This invention relates to an organic light emitting device and a display apparatus provided with the organic light emitting device, more particularly to an organic light emitting device that is formed with a through-hole for extension of a connecting member of the display apparatus therethrough.

2. Description of the Related Art

An organic light emitting device is advantageous in that is has a low power consumption, a light weight, a wide viewing angle, a high emission efficiency, a high illumination, and a low manufacturing cost, and is both flexible and lightweight. Organic light emitting devices can be used in a cellular phone, a digital camera, a video camera, a digital TV, a displaying device, etc.

FIG. 1 illustrates a conventional organic light emitting device that includes a substrate 11, an organic light emitting diode (OLED) 12 mounted on the substrate 11, and a cover 13 that covers sealingly the OLED 12 through a sealing band 15 so as to define a closed space 16 thereamong and so as to prevent oxygen and moisture from entering into the closed space 16. A moisture absorbent 14 is disposed securely in the closed space 16 for absorbing moisture therein so as to prevent damage to the OLED 12 as a result of the presence of moisture in the closed space 16.

For some applications, such as a watch, provided with the organic light emitting device therein, it is required to form holes in the cover 13 and the substrate 11 of the organic light emitting device so as to permit extension of a cylindrical pivot unit of the watch therethrough. However, gaps are formed between the cylindrical pivot unit and the cover 13 and between the cylindrical pivot unit and the substrate 11, and are relatively difficult and inconvenient to seal. As a consequence, atmospheric air can enter into the closed space 16 through the gaps, which is undesirable and which has an adverse effect on the OLED 12 in the closed space 16.

### SUMMARY OF THE INVENTION

The object of the present invention is to provide an organic light emitting device that is capable of overcoming the aforesaid drawback associated with the prior art.

According to this invention, there is provided an organic light emitting device for a display apparatus having a connecting member. The organic light emitting device comprises: a substrate; an organic light emitting diode mounted on the substrate; a cover covering the organic light emitting diode; a sealing band surrounding the organic light emitting diode and disposed between and connected sealingly to the cover and the substrate so as to cooperate with the substrate and the cover to define a closed space thereamong and so as to seal the organic light emitting diode in the closed space; and a coupling mechanism having an isolating member that is disposed in the closed space and that is connected sealingly to the cover and the substrate, and a through-hole that extends through the cover, the isolating member, and the substrate for extension of the connecting member of the display apparatus therethrough.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic sectional view of a conventional organic light emitting device;

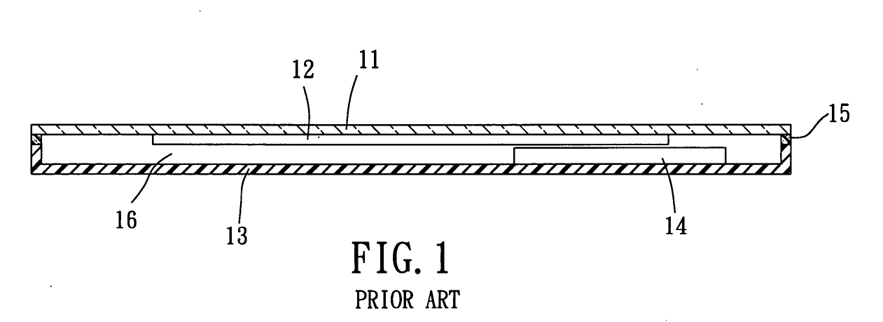

FIG. 2 is a perspective view of the first preferred embodiment of an organic light emitting device of a display apparatus according to this invention;

FIG. 3 is a schematic sectional view of the first preferred embodiment of this invention;

FIG. 4 is a fragmentary schematic sectional view to illustrate how the organic light emitting device is mounted on a cylindrical pivot unit of a connecting member of the display apparatus of the first preferred embodiment according to this invention; and

FIG. 5 is a fragmentary schematic sectional view of the second preferred embodiment of the organic light emitting device according to this invention.

### DETAILED DESCRIPTION OF THE PREFERRED EMBODIMENTS

Before the present invention is described in greater detail, it should be noted that same reference numerals have been used to denote like elements throughout the specification.

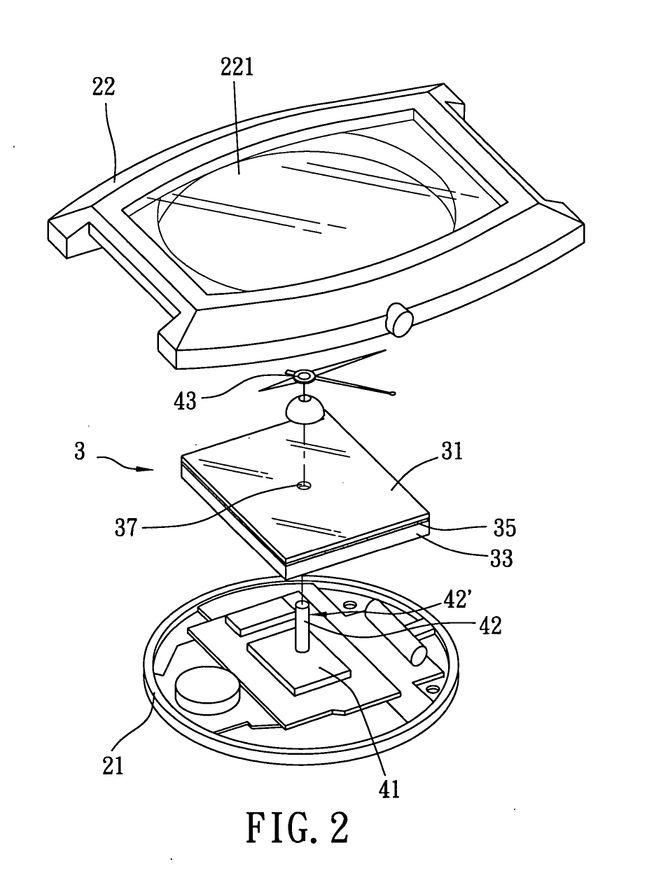

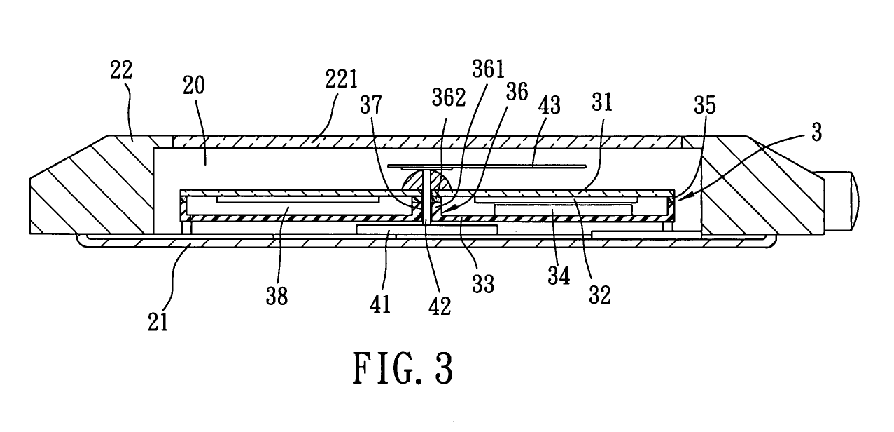

FIGS. 2 to 4 illustrate the first preferred embodiment of an organic light emitting device 3 of a display apparatus according to the present invention. In this embodiment, the display apparatus is a watch, and includes a watch casing 21 that defines an inner space 20 therein, a watch cover 22 that has a transparent sight glass 221 and that is disposed over the watch casing 21 so as to cover the inner space 20, and a connecting member 42′ mounted in the inner space 20 in the watch casing 21.

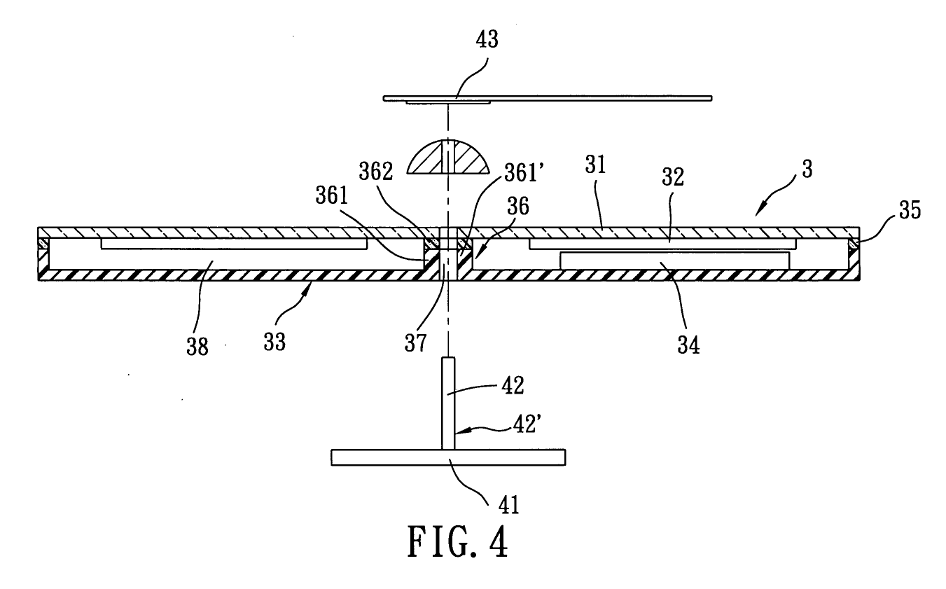

The organic light emitting device 3 (see FIG. 4) is mounted in the inner space 20, and includes: a substrate 31; an organic light emitting diode 32 mounted on the substrate 31; a transparent cover 33 covering the organic light emitting diode 32; a sealing band 35 surrounding the organic light emitting diode 32 and disposed between and connected sealingly to the cover 33 and the substrate 31 so as to cooperate with the substrate 31 and the cover 33 to define a closed space 38 thereamong and so as to seal the organic light emitting diode 32 in the closed space 38; and a coupling mechanism 36 having at least one isolating member 361 that is disposed in the closed space 38 and that is connected sealingly to the cover 33 and the substrate 31, and at least a through-hole 37 that extends through the transparent cover 33, the isolating member 36, and the substrate 31 for extension of the connecting member 42′ of the display apparatus therethrough. A moisture absorbent 34 is mounted in the closed space 38 for absorbing moisture therein.

In this embodiment, the isolating member 361 includes a post 361′ that is integrally formed with the transparent cover 33 and that extends therefrom toward the substrate 31, and a sealing element 362 that is disposed between and that is connected sealingly to the post 361′ and the substrate 31. The through-hole 37 extends through the post 361′ and the sealing element 362.

The connecting member 42′ includes a cylindrical pivot unit 42 that extends rotatably through the through-hole 37. The display apparatus further includes a hand unit 43 that is mounted to a top end of the cylindrical pivot unit 42 within the inner space 20 in the watch casing 21 and that is disposed over the organic light emitting device 3. A driving unit 41 is mounted in the inner space 20 in the watch casing 21 for driving the cylindrical pivot unit 42 to rotate.

The sealing element 362 and the sealing band 35 are preferably made from epoxy resin.

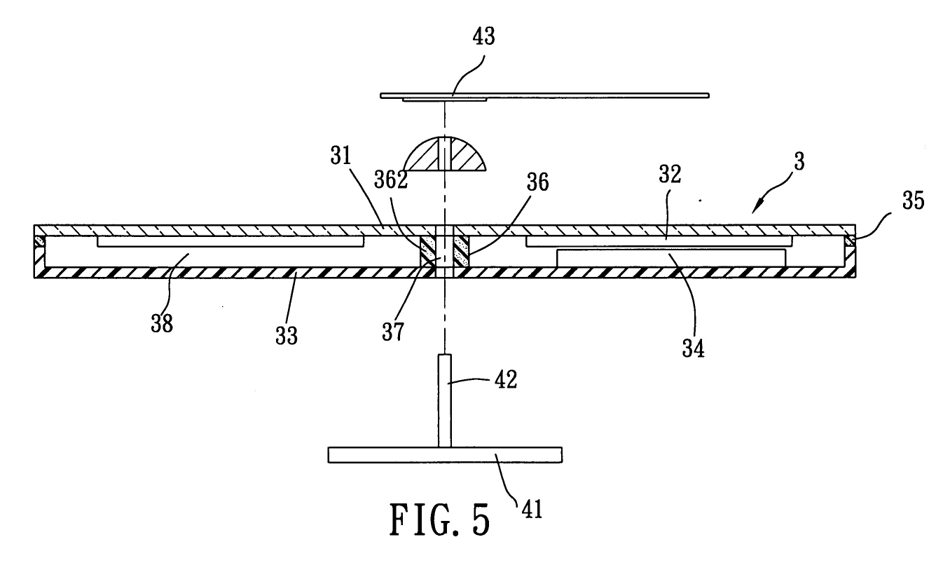

FIG. 5 illustrates the second preferred embodiment of the organic light emitting device 3 of the display apparatus according to this invention. The organic light emitting device 3 of this embodiment is similar to the previous embodiment, except that the isolating member 361 includes a sealing element 362 that is connected sealingly to the transparent cover 33 and the substrate 31. The through-hole 37 extends through the sealing element 362.

With the inclusion of the coupling mechanism 36 in the organic light emitting device 3 of the display apparatus of this invention, the aforesaid drawback associated with the prior art can be eliminated.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. An organic light emitting device for a display apparatus having a connecting member, said organic light emitting device comprising:
a substrate;
an organic light emitting diode mounted on said substrate;
a cover covering said organic light emitting diode;
a sealing band surrounding said organic light emitting diode and disposed between and connected sealingly to said cover and said substrate so as to cooperate with said substrate and said cover to define a closed space thereamong and so as to seal said organic light emitting diode in said closed space; and
a coupling mechanism having an isolating member that is disposed in said closed space and that is connected sealingly to said cover and said substrate, and a through-hole that extends through said cover, said isolating member, and said substrate for extension of the connecting member of the display apparatus therethrough.

2. The organic light emitting device of claim 1, wherein said isolating member includes a post that is integrally formed with said cover and that extends therefrom toward said substrate, and a sealing element that is disposed between and that is connected sealingly to said post and said substrate, said through-hole extending through said post and said sealing element.

3. The organic light emitting device of claim 1, wherein said isolating member includes a sealing element that is connected sealingly to said cover and said substrate, said through-hole extending through said sealing element.

4. A display apparatus comprising:
a casing defining an inner space therein;
a connecting member mounted in said inner space in said casing; and
an organic light emitting device mounted in said inner space in said casing and including
a substrate,
an organic light emitting diode mounted on said substrate,
a cover covering said organic light emitting diode,
a sealing band surrounding said organic light emitting diode and disposed between and connected sealingly to said cover and said substrate so as to cooperate with said substrate and said cover to define a closed space thereamong and so as to seal said organic light emitting diode in said closed space, and
a coupling mechanism having an isolating member that is disposed in said closed space and that is connected sealingly to said cover and said substrate, and a through-hole that extends through said cover, said isolating member, and said substrate for extension of said connecting member therethrough.

5. The display apparatus of claim 4, wherein said isolating member includes a post that is integrally formed with said cover and that extends therefrom toward said substrate, and a sealing element that is disposed between and that is connected sealingly to said post and said substrate, said through-hole extending through said post and said sealing element.

6. The display apparatus of claim 4, wherein said isolating member includes a sealing element that is connected sealingly to said cover and said substrate, said through-hole extending through said sealing element.

7. The display apparatus of claim 4, wherein said connecting member includes a cylindrical pivot unit that extends rotatably through said through-hole, said display apparatus further comprising a hand unit that is mounted to said cylindrical pivot unit within said inner space in said casing and that is disposed over said organic light emitting device, and a driving unit mounted in said casing for driving said cylindrical pivot unit to rotate.
